(19) United States
(12) Patent Application Publication
(10) Pub. No.: US 2022/0364025 A1
(43) Pub. Date: Nov. 17, 2022

(54) Fabric Care Compositions Having Improved Microbiological Robustness and Methods for the Same

(71) Applicant: Colgate-Palmolive Company, New York, NY (US)

(72) Inventors: Ana INTRIAGO, Del. Miguel Hidalgo (MX); Gabriela PEREZ CASTILLO, Col. Granada Del Miguel Hidalgo (MX); Andrea SANCHEZ, Col. Granada (MX); Raul Arellano MALDONADO, Mexico, D.F. (MX)

(73) Assignee: Colgate-Palmolive Company, New York, NY (US)

(21) Appl. No.: 17/771,636

(22) PCT Filed: Oct. 31, 2019
(86) PCT No.: PCT/US2019/059057

§ 371 Date: Apr. 25, 2022

(51) Int. Cl. C11D 3/36; C11D 3/37; C11D 3/20; C11D 3/30; C11D 11/00; C11D 3/00

(52) U.S. Cl. CPC C11D 3/361; C11D 3/373; C11D 3/2086; C11D 3/30; C11D 11/0017; C11D 3/001

(57) ABSTRACT

A fabric care composition, methods for preparing the fabric care composition, and methods for increasing microbiological robustness of the fabric care composition are disclosed. The fabric care composition may include a preservative system, a cationic softener, a cationic polymer, and an organosilicone. The method for preparing the fabric care composition may include contacting the preservative system, the cationic softener, the cationic polymer, and the organosilicone with one another.

### BACKGROUND

Conventional fabric care compositions, such as fabric softeners or detergents, may often include preservatives for improving the microbiological robustness thereof. Conventional preservatives, however, may often affect one or more consumer perceived properties of the fabric care compositions. For example, the preservatives may often affect the aesthetics and/or the sensory properties of the fabric care compositions

What is needed, then, are fabric care compositions having improved microbiological robustness and methods for the same.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a fabric care composition including a preservative system, a cationic softener, a cationic polymer, and an organosilicone. The preservative system may include one or more preservatives.

In at least one implementation, the one or more preservatives may include one or more phosphonic acids or salts thereof, one or more organic acids, or combinations thereof. The one or more phosphonic acids or salts thereof may include one or more of 1-hydroxyethane-1,1-diphosphonic acid, N,N,N-tri(phosphonomethyl)amine, 1,2-ethylenediaminetetramethylenephosphonic acid (EDTMP), diethylenetriamine pentamethylene phosphonic acid (DTPMP), N,N,N-tri(1-phosphonoethyl)amine, N,N,N-tri(1-phosphonopropyl)amine, N,N,N-tri(2-phosphonoprop-2-yl)amine, or combinations thereof. In one example, the one or more phosphonic acids or salts thereof include 1-hydroxyethane-1,1-diphosphonic acid. In at least one implementation, the one or more organic acids may include lactic acid.

In at least one implementation, the cationic softener may include an esterquat. The esterquat may be represented by formula (1), as described herein, where R₄ represents an aliphatic hydrocarbon group having from 8 to 22 carbon atoms, R₂ and R₃ represent (CH₂)ₛ—R₅, where R₅ represents an alkoxy carbonyl group containing from 8 to 22 carbon atoms, benzyl, phenyl, (C1-C4)-alkyl substituted phenyl, OH or H, where R₁ represents (CH₂)ₜ R₆, where R₆ represents benzyl, phenyl, (C1-C4)-alkyl substituted phenyl, OH or H, where q, s, and t, each independently, represent an integer from 1 to 3, and where X⁻ is a softener compatible anion.

In at least one implementation, the cationic softener may include a dialkylester of triethanolammonium methyl sulfate.

In at least one implementation, the cationic polymer includes a polyquat. For example, the cationic polymer may include Polyquaternium-7.

In at least one implementation, the organosilicone may include one or more of a polyalkyl silicone, an aminosilicone, a siloxane, a polydimethylsiloxane, an ethoxylated organosilicone, a propoxylated organosilicone, an ethoxylated/propoxylated organosilicone, or mixtures thereof.

In at least one implementation, the organosilicone may include a functionalized polydimethylsiloxane. The functionalized polydimethylsiloxane may include a mercaptoalkyl functional group, an alkylaminomethylacrylate functional group, or combinations thereof.

The foregoing and/or other aspects and utilities embodied in the present disclosure may also be achieved by providing a method for preparing any one of the fabric care compositions disclosed herein. The method may include contacting the preservative system, the cationic softener, and the organosilicone with one another.

The foregoing and/or other aspects and utilities embodied in the present disclosure may also be achieved by providing a method for increasing microbiological robustness of a fabric care composition. The method may include contacting a preservative system including one or more phosphonic acids and one or more organic acids with one another. The one or more phosphonic acids may include 1-hydroxyethane-1,1-diphosphonic acid, and the one or more organic acids may include lactic acid.

Further areas of applicability of the present disclosure will become apparent from the detailed description provided hereinafter. It should be understood that the detailed description and specific examples, while indicating some typical aspects of the disclosure, are intended for purposes of illustration only and are not intended to limit the scope of the disclosure.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a plot or graphical representation of Formula (7).

FIG. 2 illustrates a plot or graphical representation of Formula (8).

FIG. 3 illustrates a plot or graphical representation of Formula (9).

FIG. 4 illustrates a plot or graphical representation of Formula (10).

FIG. 5 illustrates a plot or graphical representation of Formula (11).

FIG. 6 illustrates a plot or graphical representation of Formula (12).

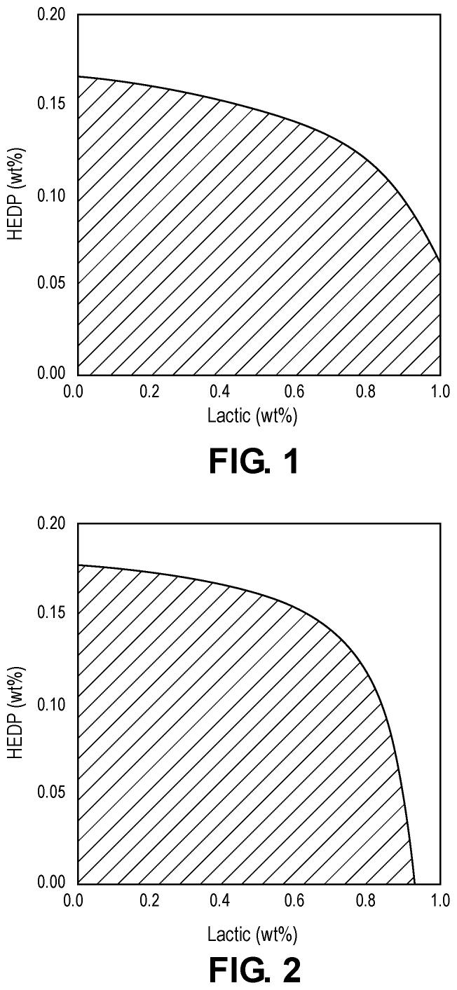

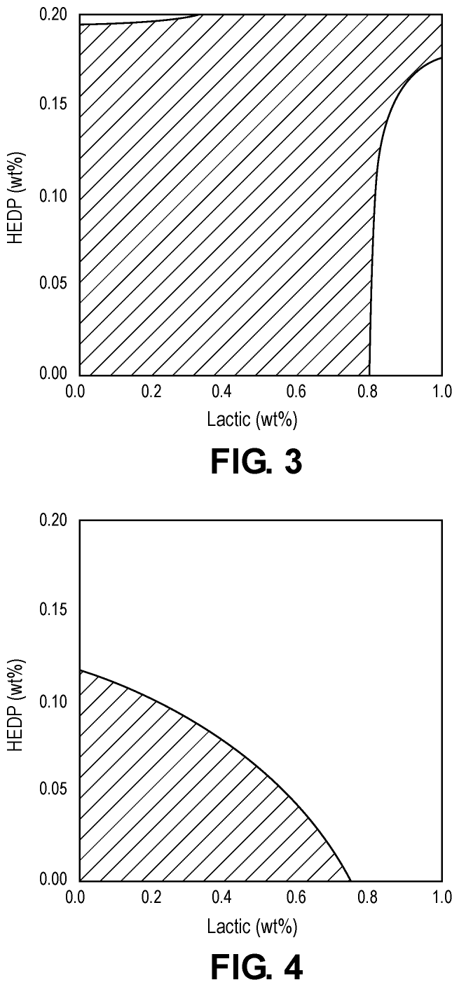

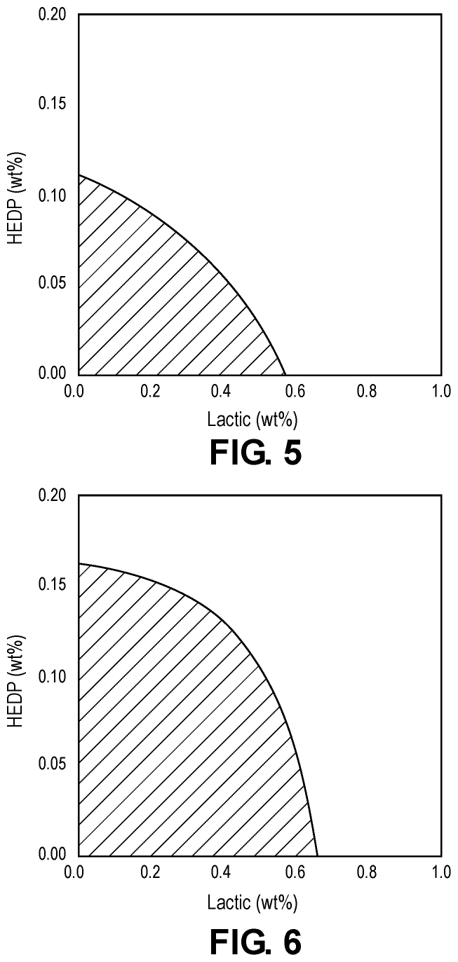

### DETAILED DESCRIPTION

The following description of various typical aspect(s) is merely exemplary in nature and is in no way intended to limit the disclosure, its application, or uses.

As used throughout this disclosure, ranges are used as shorthand for describing each and every value that is within the range. It should be appreciated and understood that the description in a range format is merely for convenience and brevity, and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Unless otherwise specified, all percentages and amounts expressed herein and elsewhere in the specification should be understood to refer to percentages by weight. The amounts given are based on the active weight of the material.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

As used herein, “free” or “substantially free” of a material may refer to a composition, component, or phase where the material is present in an amount of less than 10.0 weight %, less than 5.0 weight %, less than 3.0 weight %, less than 1.0 weight %, less than 0.1 weight %, less than 0.05 weight %, less than 0.01 weight %, less than 0.005 weight %, or less than 0.0001 weight % based on a total weight of the composition, component, or phase.

All references cited herein are hereby incorporated by reference in their entireties. In the event of a conflict in a definition in the present disclosure and that of a cited reference, the present disclosure controls.

The present inventors have surprisingly and unexpectedly discovered that fabric care compositions including one or more surfactants, such as esterquats, a preservative system including one or more phosphonic acids or polyphosphonic acids, such as 1-hydroxyethylidine-1,1-diphosphonic acid (HEDP) or etidronic acid and one or more organic acids, such as lactic acid, one or more organosilicones, or combinations thereof exhibit relatively improved or greater microbiological robustness as compared to conventional fabric care compositions. Particularly, the inventors have surprisingly and unexpectedly discovered that fabric care compositions including esterquats, a preservative system including a combination of etidronic acid and lactic acid, functionalized polydimethylsiloxanes, or combinations thereof exhibit relatively improved or greater microbiological robustness as compared to conventional fabric care compositions. The relatively or greater microbiological robustness was demonstrated without compromising or decreasing one or more customer perceived properties for the fabric care composition. For example, the fabric care compositions disclosed herein exhibited greater microbiological robustness while maintaining or improving softness, yellowing, product stability, fabric protection, shape retention of fabrics, anti-wrinkle benefits, long lasting fragrance, or combinations thereof. As further described herein, the fabric care compositions were particularly robust against acidophilic bacteria.

### Compositions

Compositions disclosed herein may be or include a fabric care product or a fabric care composition thereof. For example, the composition may be a fabric care product including the fabric care composition, or the fabric care composition thereof. The fabric care composition may be or include a solid, such as a water hydratable solid (e.g., a water hydratable film) or a liquid (e.g., liquid fabric softener). The fabric care composition may include one or more cationic softeners (e.g., Polyquaternium), such as one or more esterquats, a preservative system or one or more preservatives, one or more cationic polymers, one or more organosilicones, or combinations thereof.

As used herein, the term or expression “fabric care product” may refer to products for treating fabrics, textiles, garments, and/or surfaces thereof. Illustrative fabric care products may be or include, but are not limited to, washing agents, such as laundry detergents, fabric conditioning products, softening and/or freshening products that may be in a solid form, or combinations thereof. As used herein, the term or expression “fabric care composition” may refer to compositions for treating or caring for fabrics. Illustrative fabric care compositions may be or include, but are not limited to, compositions for cleaning, treating, or caring for fabrics, compositions for conditioning and/or softening fabrics, compositions for freshening fabrics, compositions for adding and/or providing fragrances to fabrics, including extended release fragrances to fabrics, or combinations thereof.

### Cationic Softener/Esterquat

The fabric care composition may include one or more cationic softeners. For example, the fabric care composition may include one or more esterquats as the cationic softener. The one or more esterquats may be or include, but is not limited to, an esterquat that is a quaternized reaction product of an alkanol amine and a fatty acid. The one or more esterquats may have the following structural formula:

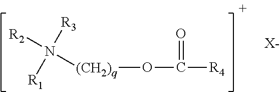

wherein R₄ represents an aliphatic hydrocarbon group having from 8 to 22 carbon atoms, R₂ and R₃ represent (CH₂)ₛ—R₅, where R₅ represents an alkoxy carbonyl group containing from 8 to 22 carbon atoms, benzyl, phenyl, (C1-C4)-alkyl substituted phenyl, OH or H; R₁ represents (CH₂)ₜ R₆, where R₆ represents benzyl, phenyl, (C1-C4)-alkyl substituted phenyl, OH or H; where q, s, and t, each independently, represent an integer from 1 to 3; and X⁻ is a softener compatible anion.

The esterquat may generally be produced by reacting one or more fatty acid methyl esters with one or more alkanol amines, followed by quaternization with dimethyl sulfate. Additional details regarding the preparation of the esterquat are disclosed in U.S. Pat. No. 3,915,867, the contents of which are incorporated herein to the extent consistent with the present disclosure). The alkanol amine may include triethanol amine. The fatty acids may be any suitable fatty acid used for manufacturing esterquats for fabric softening. In at least one implementation, the fatty acid may include any fatty acid having from 12 to 22 carbon atoms, typically from 16 to 18 carbon atoms. Illustrative fatty acids, may include, but are not limited to, coconut oil, palm oil, tallow, rape oil, fish oil, chemically synthesized fatty acids, or combinations thereof. In at least one implementation, the fatty acid is tallow.

Illustrative esterquats may be or include, but are not limited to, quaternized difatty acid esters of triethanolamine, quaternized triethanolamine ditallow fatty acid ester, esters of triethanolammonium methyl sulphate, particularly tallow or hardened tallow esters, such as dialkylesters of triethanolammonium methyl sulfate, methyl bix(ethyl tallowate)-2-hydroxyethyl ammonium methyl sulfate, di(tallow alkyl)dimethyl ammonium methyl sulphate, dihexadecyl dimethyl ammonium chloride, di(hydrogenated tallow alkyl)dimethyl ammonium chloride, dioctadecyl dimethyl ammonium chloride, di(hydrogenated tallow alkyl)dimethyl ammonium methyl sulphate, dihexadecyl diethyl ammonium chloride, di(coconut alkyl)dimethyl ammonium chloride, ditallow alkyl dimethyl ammonium chloride, and di(hydrogenated tallow alkyl)dimethyl ammonium chloride, or combinations thereof. Illustrative esterquats may also be or include, but are not limited to, triethanolamine (TEA) esterquats (e.g., methyl bis(ethyl tallowate)-2-hydroxyethyl ammonium methyl sulfate), methyldiethanolamine (MDEA) esterquats, diamidoquats (e.g., methyl bis(hydrogenated tallow amidoethyl)-2-hydroxyethyl ammonium methyl sulfate), and dialkyldimethyl quats (e.g., dihydrogenated tallow dimethyl ammonium chloride), or combinations thereof. In an exemplary implementation, the esterquats include a dialkylester of triethanolammonium methyl sulfate.

The one or more esterquats may be present in the fabric care composition in an amount of from about 1 wt % to about 15 wt %, based on a total weight of the fabric care composition. For example, the amount of the one or more esterquats present in the fabric care composition may be from about 1 wt %, about 3 wt %, about 4 wt %, or about 5 wt % to about 6 wt %, about 7 wt %, about 8 wt %, about 9 wt %, about 10 wt %, or about 15 wt %, based on a total weight of the fabric care composition. In an exemplary implementation, the fabric care composition includes the one or more esterquats in an amount of about 3 wt %, about 5 wt %, or about 8 wt %. For example, the fabric care composition may include the one or more esterquats in an amount of about 2.7 wt %, about 5.2 wt %, or about 7.9 wt %, based on a total weight of the fabric care composition.

### Preservatives

The fabric care composition may include one or more preservatives or a preservative system including one or more preservatives. The preservative system or the one or more preservatives of the fabric care composition may be capable of or configured to at least partially increase the microbiological robustness of the fabric care composition. Illustrative preservative may include, but are not limited to, one or more phosphonic acids or polyphosphonic acids or salts thereof, one or more organic acids, amino trimethyl phosphonic acid, isothiazolinones, a (OIT/MIT/CIT) isothiazolinone mixture, or the like, or combinations thereof. Illustrative organic acids may be or include, but are not limited to, lactic acid, acetic acid, formic acid, citric acid, oxalic acid, uric acid, malic acid, or combinations thereof. Illustrative polyphonic acids may be or include, but are not limited to, 1-hydroxyethane-1,1-diphosphonic acid (etidronic acid), N,N,N-tri(phosphonomethyl)amine, 1,2-ethylenediaminetetramethylenephosphonic acid (EDTMP), diethylenetriaminepentamethylenephosphonic acid (DTPMP), N,N,N-tri(1-phosphonoethyl)amine, N,N,N-tri(1-phosphonopropyl)amine, N,N,N-tri(2-phosphonoprop-2-yl)amine, or combinations thereof. In an exemplary implementation, the one or more polyphonic acids includes etidronic acid. In an exemplary implementation, the fabric care composition may include one or more phosphonic or polyphosphonic acids, one or more organic acids, or a combination thereof. For example, the preservative system of the fabric care composition includes a combination of etidronic acid and lactic acid. It should be appreciated that etidronic acid may also function as a chelator. In at least one implementation, the fabric care composition may be free or substantially free of any other chelator except etidronic acid. As such, it should be appreciated that etidronic acid may provide functionality as both a preservative and a chelator.

In an exemplary implementation, the fabric care composition or the preservative system thereof may be free or substantially free of isothiazolinones or mixtures thereof. As used herein, “free” or “substantially free” of a material may refer to a composition, component, or phase where the material is present in an amount of less than 10.0 weight %, less than 5.0 weight %, less than 3.0 weight %, less than 1.0 weight %, less than 0.1 weight %, less than 0.05 weight %, less than 0.01 weight %, less than 0.005 weight %, or less than 0.0001 weight % based on a total weight of the composition, component, or phase. In some instances, “substantially free” of a material or component may also mean that no amount of that material or component is deliberately incorporated into the composition.

The amount of any one or more preservatives present in the fabric care composition may vary widely. For example, any one or more of the preservatives may be present in the fabric care composition in an amount of greater than 0 wt %, about 0.05 wt %, about 0.0625 wt %, about 0.1 wt %, about 0.125 wt %, about 0.1875 wt %, or about 0.2 wt % to about 0.25 wt %, about 0.3 wt %, about 0.3125 wt %, about 0.3750 wt %, or 0.4375 wt %, based on a total weight of the fabric care composition. The amount of any one or more of the preservatives present in the fabric care composition may be effective to improve or provide sufficient microbiological robustness to the fabric care composition, particularly against acidophilic bacteria, while maintaining or improving softness, yellowing, or any other consumer perceived properties of the fabric care composition.

As discussed above, in an exemplary implementation, the fabric care composition includes a phosphonic or polyphosphonic acid and an organic acid. A weight ratio of the phosphonic or polyphosphonic acid to the organic acid may be from about 0.1:1, about 0.5:1, about 0.6:1, about 0.7:1, about 0.8:1, about 0.9:1, or about 1:1 to about 1.1:1, about 1.2:1, about 1.3:1, about 1.4:1, about 1.5:1, or about 2:1.

### Cationic Polymers

In at least one implementation, the one or more cationic polymers may be or include, but are not limited to, one or more cationic polysaccharides, polyethylene imine, derivatives thereof, or combinations thereof. Illustrative cationic polymers may be or include, but are not limited to, poly(acrylamide-co-diallyldimethylammonium chloride), poly(acrylamide-methacrylamido propyl trimethylammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamido propyl trimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinylimidazole), poly(acrylamide-co-Methacryloamidopropyl-pentamethyl-1,3-propylene-2-ol-ammonium dichloride), or combinations an mixtures thereof. Additional illustrative cationic polymers may be or include, but are not limited to, polyquats, such as Polyquaternium-1, Polyquaternium-2, Polyquaternium-4, Polyquaternium-5, Polyquaternium-6, Polyquaternium-7, Polyquaternium-8, Polyquaternium-9, Polyquaternium-10, Polyquaternium-11, Polyquaternium-12, Polyquaternium-13, Polyquaternium-14, Polyquaternium-15, Polyquaternium-16, Polyquaternium-17, Polyquaternium-18, Polyquaternium-19, Polyquaternium-20, Polyquaternium-22, Polyquaternium-24, Polyquaternium-27, Polyquaternium-28, Polyquaternium-29, Polyquaternium-30, Polyquaternium-31, Polyquaternium-32, Polyquaternium-33, Polyquaternium-34, Polyquaternium-35, Polyquaternium-36, Polyquaternium-37, Polyquaternium-39, Polyquaternium-42, Polyquaternium-43, Polyquaternium-44, or combinations thereof, as named under the International Nomenclature for Cosmetic Ingredients (INCI). In a preferred implementation, the one or more cationic polymers include a copolymer of acrylamide and a quaternium ammonium salt, diallyldimethylammonium chloride, or Polyquaternium-7.

The one or more cationic polymers may be present in the fabric care composition in an amount of from greater than 0 wt % to less than or equal to about 5 wt %, based on a total weight of the fabric care composition. For example, the fabric care composition may include the one or more cationic polymers in an amount of from about 0.01 wt %, about 0.1 wt %, about 0.5 wt %, about 1 wt %, about 2 wt %, or about 3 wt % to about 3.5 wt %, about 4 wt %, or about 5 wt %, based on a total weight of the fabric care composition.

### Organosilicones

The fabric care composition may include one or more organosilicones. The one or more organosilicones may be capable of or configured to provide softness, softening, or smoothness to fabrics or textiles after laundering. The organosilicones may also be capable of or configured to provide a substantial color appearance benefit to fabrics and/or provide an anti-abrasion benefit to the fabrics by reducing friction of the fibers during laundering. The one or more organosilicones may include, but are not limited to, a polyalkyl silicone, an aminosilicone, a siloxane, a polydimethylsiloxane, an ethoxylated organosilicone, a propoxylated organosilicone, an ethoxylated/propoxylated organosilicone, or mixtures thereof.

Suitable organosilicones may include Si—O moieties and may include or be selected from non-functionalized siloxane polymers, functionalized siloxane polymers, or combinations thereof. The organosilicones may have a viscosity of from about 10 centipoise (cP) to about 500,000 cP, about 1,000,000 cP, about 1,500,000 cP, or about 2,000,000 cP at about 25° C. Any one of more of the organosilicones may be linear, branched, or cross-linked. The organosilicones may be in the form of or provided as a neat liquid, combined with one or more solvents, or an emulsion in water. In at least one implementation, the one or more organosilicones may include a functionalized polydimethylsiloxane, where the functional groups include a mercaptoalkyl functional group, an alkylaminomethyacrylate functional group, or combinations thereof. For example, the one or more organosilicones may be or include, but is not limited to, one or more silicone fluids and/or fluid emulsions, such as WACKER® FC 201, FC 204, FC 207, FC 218, FC 223, or the like, or combinations thereof, each of which are commercially available from Wacker Chemie AG of Munich, Germany. In an exemplary implementation, the one or more organosilicones includes WACKER® FC 204 (Chemical Abstract Service [CAS] No. 340795-93-9), a composition including a self-dispersing aminofunctional silicone fluid having about 20% aminosilicone and a density of about 1 g/mL at about 20° C.

### Carrier

The fabric care composition may include one or more water-soluble or water-dispersible solvents capable of or configured to act as a carrier for any one or more of the remaining components of the fabric care composition. Illustrative water-soluble or water-dispersible solvents may be or include, but are not limited to, water, C4 to C10 glycol ethers, C2 to C7 glycols, polyethers, glycerin, or the like, or combinations thereof. For example, the fabric care composition may include any one or more of water, propylene glycols, ethylene glycols, polyethylene glycols, glycerin, or the like, or combinations thereof. In an exemplary implementation, the fabric care composition may include water as the carrier.

Water of the fabric care composition may be deionized water, demineralized water, and/or softened water. Water may make up the balance of the fabric care composition. For example, the amount of water present in the fabric care composition may be greater than or equal to 60 weight %, greater than or equal to 65 weight %, greater than or equal to 70 weight %, greater than or equal to 75 weight %, greater than or equal to 80 weight %, greater than or equal to 85 weight %, greater than or equal to 90 weight %, greater than or equal to 92 weight %, greater than or equal to 94 weight %, greater than or equal to 96 weight %, greater than or equal to 98 wt %, or greater than or equal to 99 wt %, based on a total weight of the fabric care composition. The amount of water in the fabric care composition may include free water added and water introduced with other components or materials of the fabric care composition. For example, the amount of the water in the fabric care composition may include free water and water associated with one or more surfactants and/or any other components of the fabric care composition.

### Additional Ingredients

It should be appreciated by one having ordinary skill in the art, that the fabric care products and/or the fabric care composition thereof may include other additional ingredients/components. The additional ingredients/components may be capable of or configured to enhance the appearance, perception, and/or the performance of the fabric care compositions. The additional ingredients/components may be present in respective amounts of from greater than 0 wt % to less than or equal to 5 wt %, based on a total weight of the fabric care composition. Illustrative additional ingredients/components may be or include, but are not limited to, fragrances, perfumes, thickeners, dyes and/or pigments, bluing agents, germicides, opacifying agents, anti-foaming agents, or the like, or combinations thereof.

The fabric care composition may include one or more fabric conditioning ingredients or agents. The fabric conditioning agent may be or include one or more fatty alcohols. The fatty alcohol may be of natural or synthetic origin and may include, for example, mixed alcohol, such as C₁₆-C₁₈ alcohols prepared by Ziegler polymerization of ethylene. The fatty alcohol may be ethoxylated. The hydrophobic group of the fatty alcohol may be a straight or branched chain alkyl or alkenyl group having from about 10 to about 24, preferably from about 10 to about 20, especially preferably from about 12 to about 20 carbon atoms. Illustrative fatty alcohols may be or include, but are not limited to, decanol (e.g., 1-decanol), dodecanol, tetradecanol, pentadecanol, hexadecanol, octadecanol, lauryl alcohol, palmityl alcohol, stearyl alcohol, oleyl alcohol, or the like, or combinations and mixtures thereof. In at least one implementation, the composition may include a C₁₄-C₁₅ or C₁₃-C₁₅ Fatty Alcohol EO 20:1, which is a nonionic surfactant including about 20 ethoxylate groups. In at least one implementation, the fatty alcohol may be TENSAPOL™, which is commercially available from Polioles of Mexico.

The fabric care composition may include one or more fragrances or perfumes. As used herein, the term or expression “fragrance” or “perfume” may be used in its ordinary sense to refer to or include any water soluble or non-water soluble fragrant substance or mixture of substances including natural fragrances (i.e., obtained by extraction of flower, herb, blossom or plant), artificial fragrances (i.e., mixture of natural oils or oil constituents), synthetically produced odoriferous substances or fragrances, or combinations thereof.

The fabric care composition may include free fragrances, encapsulated fragrances, or a mixture thereof. For example, the fabric care composition may include one or more free fragrances dispersed throughout the fabric care composition, such as dispersed in the aqueous carrier (e.g., water). In another example, the one or more fragrances may be encapsulated in capsules. For example, the fabric care composition may include capsules containing the fragrances, and the capsules may be dispersed throughout the fabric care composition.

The capsules may be capable of or configured to contain the one or more fragrances. The capsules may be fabricated from any suitable material or materials that are capable of or configured to encapsulate the one or more fragrances, and compatible with one or more of the remaining components of the fabric care composition. For example, the capsules may be fabricated from any suitable material or materials that are capable of or configured to encapsulate the one or more fragrances, and compatible with the one or more preservatives. The capsules may also be fabricated from any suitable material that allows the release of the fragrance contained therein through diffusion of the fragrance through walls of the capsules, rupture of the capsules, or combinations thereof. For example, the capsules may be fabricated from any suitable material or materials that allow the diffusion of the fragrance through the walls, thereby providing fragrance delivery for at least 1 day, at least 2 days, at least 5 days, at least 15 days, at least 30 days, at least 60 days, at least 90 days, at least 120 days, or more. In another example, the capsules may be fabricated from any suitable material or materials that allow the fragrances to be release when the capsules are ruptured, thereby providing immediate release of the fragrances.

In at least one implementation, the capsules may include or be formed from one or more of polyurethane, polysiloxanes, polyurea, polyamide, polyimide, polyvinyl alcohol, polyanhydride, polyolefin, polysulfone, polysaccharide, protein, polylactide (PLA), polyglycolide (PGA), polyorthoester, polyphosphazene, silicone, lipid, modified cellulose, gums, polystyrene, polyesters, ethylene maleic anhydride copolymer, styrene maleic anhydride copolymer, ethylene vinyl acetate copolymer, lactide glycolide copolymer, or the like, or combinations thereof. In at least one implementation, the capsules may include or be formed from urea-formaldehyde, melamine-formaldehyde phenolic-formaldehyde, urea-glutaraldehyde, melamine-glutaraldehyde, phenolic-glutaraldehyde, polyurea (isocyanate-based), polyurethane, acrylate-based hydrogels, polyurea/polyurethane-acrylic hybrid materials, polyamide based materials, polyester-based materials, epoxy-based cross-linkers, silk fibroin capsules, silica and silica-derived materials, or the like, or combinations thereof. In at least one implementation, the selection of the materials used to form the capsules may be at least partially determined by the surface charge or desired surface charge of the capsules. For example, the materials used to form the capsules may provide a net cationic or net anionic charge on outer surfaces of the capsules, which may facilitate adhesion or attraction of the capsules to the fabric or the fibers thereof.

The fabric care composition disclosed herein, may provide microbiological robustness for a period of time relatively greater than convention fabric care compositions. The fabric care compositions disclosed herein may also provide relatively greater or improved microbiological robustness, especially against acidophilic bacteria, than conventional fabric care compositions. Particularly, the fabric care compositions disclosed herein may exhibit a 3-log reduction in microbes.

### Methods

The present disclosure may provide methods for improving microbiological robustness of a fabric care composition. In some examples, the methods disclosed herein may provide improved microbiological robustness as compared to conventional fabric care compositions while maintaining consumer perceived properties of the fabric care composition. The method may include preparing a preservative system including a combination of preservatives in an effective amount. For example, the method may include combining or otherwise contacting a phosphonic or polyphosphonic acid and an organic acid with one another to prepare the preservative system. The method may further include mixing, combining, or otherwise contacting the preservative system or the preservatives thereof with one or more esterquats, one or more cationic polymers, one or more organosilicones, one or more additional ingredients, or combinations thereof to prepare the fabric care composition.

In an exemplary implementation, the methods disclosed herein may be or include reducing or preventing microbiological growth or proliferation of microbes, especially acidophilic bacteria. Illustrative acidophilic bacteria may be or include, but are not limited to, Gluconobacter sp., Acetobacter sp., Gluconacetobacter sp., or the like, or combinations thereof.

The present disclosure also provides methods for softening a fabric. The method may include treating the fabric with the fabric care compositions disclosed herein or produced by the methods disclosed herein.

The present disclosure may also provide methods for preparing fabric care compositions having microbiological robustness of greater than or equal to 3 (Log ≥3) and a pH of greater than or equal to 2 (≥2). The method may include providing an esterquat in an amount of about 2.7 wt % without any polydimethylsiloxane (e.g., functionalized polydimethylsiloxane). The method may also include providing lactic acid and etidronic acid in an amount according to Formula (1)

0<−7.22+6.50·X+42.20·Y−33.80·X·Y Formula (1)

where X is the amount (wt %) of lactic acid present and Y is the amount (wt %) of etidronic acid present. Accordingly, a satisfactory fabric care composition including an esterquat in an amount of about 2.7 wt % and having microbiological robustness of greater than or equal to 3 (Log ≥3) and a pH of greater than or equal to 2 (≥2) may be prepared when the amount of lactic acid and etidronic acid are provided in respective amounts such that the value of Formula (1) is greater than zero (0).

The present disclosure may also provide methods for preparing fabric care compositions having microbiological robustness of greater than or equal to 3 (Log ≥3) and a pH of greater than or equal to 2 (≥2). The method may include providing an esterquat in an amount of about 5.2 wt % without any polydimethylsiloxane (e.g., functionalized polydimethylsiloxane). The method may also include providing lactic acid and etidronic acid in an amount according to Formula (2)

0<−6.34+6.50·X+34.56·Y−33.80·X·Y Formula (2)

where X is the amount (wt %) of lactic acid present and Y is the amount (wt %) of etidronic acid present. Accordingly, a satisfactory fabric care composition including an esterquat in an amount of about 5.2 wt % and having microbiological robustness of greater than or equal to 3 (Log ≥3) and a pH of greater than or equal to 2 (≥2) may be prepared when the amount of lactic acid and etidronic acid are provided in respective amounts such that the value of Formula (2) is greater than zero (0).

The present disclosure may also provide methods for preparing fabric care compositions having microbiological robustness of greater than or equal to 3 (Log ≥3) and a pH of greater than or equal to 2 (≥2). The method may include providing an esterquat in an amount of about 7.9 wt % without any polydimethylsiloxane (e.g., functionalized polydimethylsiloxane). The method may also include providing lactic acid and etidronic acid in an amount according to Formula (3)

0<−5.40+6.50·X+26.41·Y−33.80·X·Y Formula (3)

where X is the amount (wt %) of lactic acid present and Y is the amount (wt %) of etidronic acid present. Accordingly, a satisfactory fabric care composition including an esterquat in an amount of about 7.9 wt % and having microbiological robustness of greater than or equal to 3 (Log ≥3) and a pH of greater than or equal to 2 (≥2) may be prepared when the amount of lactic acid and etidronic acid are provided in respective amounts such that the value of Formula (3) is greater than zero (0).

The present disclosure may also provide methods for preparing fabric care compositions having microbiological robustness of greater than or equal to 3 (Log ≥3) and a pH of greater than or equal to 2 (≥2). The method may include providing an esterquat in an amount of about 2.7 wt % with at least one polydimethylsiloxane (e.g., a functionalized polydimethylsiloxane). The method may include providing the polydimethylsiloxane in an amount of about 0.17 wt %. The method may further include providing lactic acid and etidronic acid in an amount according to Formula (4)

0<−5.04+6.50·X+42.20·Y−33.80·X·Y Formula (4)

where X is the amount (wt %) of lactic acid present and Y is the amount (wt %) of etidronic acid present. Accordingly, a satisfactory fabric care composition including an esterquat in an amount of about 2.7 wt %, a polydimethylsiloxane in an amount of about 0.17 wt %, and having microbiological robustness of greater than or equal to 3 (Log ≥3) and a pH of greater than or equal to 2 (≥2) may be prepared when the amount of lactic acid and etidronic acid are provided in respective amounts such that the value of Formula (4) is greater than zero (0).

The present disclosure may also provide methods for preparing fabric care compositions having microbiological robustness of greater than or equal to 3 (Log ≥3) and a pH of greater than or equal to 2 (≥2). The method may include providing an esterquat in an amount of about 5.2 wt % with at least one polydimethylsiloxane (e.g., a functionalized polydimethylsiloxane). The method may include providing the polydimethylsiloxane in an amount of about 0.3 wt %. The method may further include providing lactic acid and etidronic acid in an amount according to Formula (5)

0<−3.90+6.50·X+34.56·Y−33.80·X·Y Formula (5)

where X is the amount (wt %) of lactic acid present and Y is the amount (wt %) of etidronic acid present. Accordingly, a satisfactory fabric care composition including an esterquat in an amount of about 5.2 wt %, a polydimethylsiloxane in an amount of about 0.3 wt %, and having microbiological robustness of greater than or equal to 3 (Log ≥3) and a pH of greater than or equal to 2 (≥2) may be prepared when the amount of lactic acid and etidronic acid are provided in respective amounts such that the value of Formula (5) is greater than zero (0).

The present disclosure may also provide methods for preparing fabric care compositions having microbiological robustness of greater than or equal to 3 (Log ≥3) and a pH of greater than or equal to 2 (≥2). The method may include providing an esterquat in an amount of about 7.9 wt % with at least one polydimethylsiloxane (e.g., a functionalized polydimethylsiloxane). The method may include providing the polydimethylsiloxane in an amount of about 0.47 wt %. The method may further include providing lactic acid and etidronic acid in an amount according to Formula (6)

0<−4.46+6.50·X+26.41·Y−33.80·X·Y Formula (6)

where X is the amount (wt %) of lactic acid present and Y is the amount (wt %) of etidronic acid present. Accordingly, a satisfactory fabric care composition including an esterquat in an amount of about 7.9 wt %, a polydimethylsiloxane in an amount of about 0.47 wt %, and having microbiological robustness of greater than or equal to 3 (Log ≥3) and a pH of greater than or equal to 2 (≥2) may be prepared when the amount of lactic acid and etidronic acid are provided in respective amounts such that the value of Formula (6) is greater than zero (0).

### EXAMPLES

The examples and other implementations described herein are exemplary and not intended to be limiting in describing the full scope of compositions and methods of this disclosure. Equivalent changes, modifications and variations of specific implementations, materials, compositions and methods may be made within the scope of the present disclosure, with substantially similar results.

### Example 1

The microbiological efficacy of varying fabric care compositions was evaluated. Particularly, fabric care compositions (1)-(71) including varying amounts and/or ratios of lactic acid, etidronic acid, esterquats, functionalized polydimethylsiloxane, or combinations thereof were prepared according to Tables 1 and 2 and evaluated for their microbiological efficacy and/or robustness according to a standardized test, namely, an Acid Antimicrobial Preservation Effectiveness Test (AAPET). The AAPET analysis was performed according to the guidelines described by Quality Micro Procedure (QMIC) 0058—Acidophilic Bacteria >99.9%. According to the AAPET analysis, a bacteria pool was added to about 40 g of the fabric care compositions (1)-(71), homogenized, and incubated for seven days. After incubation, an aliquot was taken and the amount of the microorganisms/bacteria that survived is counted. After seven days, a new bacteria pool is added into the sample and incubated for another seven days. After the seven days (14 days total), another aliquot was taken and the amount of the microorganisms/bacteria that survived is counted. This procedure is repeated for a total of 35 days. To pass the test, the logarithmic reduction of the bacteria must be at least 3 (99.9%) each time the aliquot is taken for testing.

The results of the AAPET analysis are represented by the Log values in Tables 1 and 2. It should be appreciated that a Log value lower than 3, as determined according to the AAPET, was considered to not pass or not provide sufficient microbiological robustness. Similarly, a Log value of 3 or greater, as determined according to the AAPET, was considered to pass or provide sufficient microbiological robustness. As illustrated below, a relatively broader range and/or ratio of the lactic acid and etidronic acid was evaluated (Table 1), as well as a relatively lower amount and/or narrower range of the lactic acid and etidronic acid (Table 2).

In addition to evaluating the microbiological efficacy, the speed separation and pH (i.e., initial pH and pH after 13 weeks of aging) of each of the fabric care compositions (1)-(71) was evaluated. To evaluate the speed separation, about 400 μL of each of the fabric care compositions (1)-(71) was centrifuged with a LumiSizer Dispersion Analyzer LUM for about 15 hours at about 40° C. The speed separation value was calculated based on a front tracking in μm/seg.

TABLE 1
Fabric Care Compositions (1)-(13)

| | Lactic Acid − | Etidronic Acid − | | | | | | pH |
|---|---|---|---|---|---|---|---|---|
| | 80% (LA) | 60% (HEDP) | Esterquat | PDMS^{A} | | Speed Sep | Initial | @ 13 |
| Sample | (wt %) | (wt %) | (EQ) (wt %) | (wt %) | LOG | (μm/seg) | pH | wks |
| 1 | 0.5 | 0 | 2.7 | 0.0 | −1.8 | 0.7725 | 2.63 | 2.58 |
| 2 | 1.0 | 0.2 | 2.7 | 0.0 | 4.3 | 1.3333 | 2.01 | 2.18 |
| 3 | 0.5 | 0.2 | 7.9 | 0.47 | 4.3 | 0.0061 | 1.99 | 2.24 |
| 4 | 0 | 0 | 2.7 | 0.235 | −1.1 | 0.7543 | 2.97 | 3.01 |
| 5 | 0 | 0.2 | 5.2 | 0.0 | 4.3 | 0.0075 | 2.04 | 2.22 |
| 6 | 0 | 0.2 | 2.7 | 0.47 | 4.3 | 1.493 | 2.04 | 2.24 |
| 7 | 0.5 | 0.1 | 5.2 | 0.235 | 4.3 | 0.0826 | 2.06 | 2.8 |
| 8 | 1 | 0 | 7.9 | 0.0 | 4.3 | 0.0027 | 2.52 | 2.48 |
| 9 | 0 | 0 | 7.9 | 0.47 | −1.5 | 0.0176 | 3.07 | 2.95 |
| 10 | 0 | 0.1 | 7.9 | 0.0 | −0.20 | 0.0037 | 2.41 | 2.52 |
| 11 | 1 | 0 | 5.2 | 0.47 | 4.2 | 0.1015 | 2.32 | 2.51 |
| 12 | 1 | 0.2 | 7.9 | 0.235 | 4.3 | 0.0045 | 2.15 | 2.2 |
| 13 | 1 | 0.1 | 2.7 | 0.47 | 4.3 | 0.8591 | 2.28 | 2.35 |

^{A}PDMS = Functionalized Polydimethysiloxane

TABLE 2
Exemplary Fabric Care Compositions (14)-(71)

| | LA | HEDP | EQ | PDMS^{A} | | Speed | Initial | pH @ |
|---|---|---|---|---|---|---|---|---|
| Sample | (wt %) | (wt %) | (wt %) | (wt %) | LOG | Sep. | pH | 13 wks |
| 14 | 0.1250 | 0.00 | 2.7 | 0.0 | 0 | 0.953 | — | — |
| 15 | 0.1250 | 0.08 | 2.7 | 0.0 | 2.8 | 0.4449 | — | 2.44 |
| 16 | 0.1250 | 0.10 | 2.7 | 0.0 | 3.1 | 0.1949 | 2.24 | 2.43 |
| 17 | 0.1250 | 0.10 | 2.7 | 0.0 | 3.1 | 0 | 2.24 | 2.43 |
| 18 | 0.1250 | 0.10 | 2.7 | 0.0 | 3.7 | 0 | — | 2.48 |
| 19 | 0.1250 | 0.00 | 2.7 | 0.17 | 0 | 3.522 | — | — |
| 20 | 0.1250 | 0.08 | 2.7 | 0.17 | 1.9 | 2.293 | 2.81 | 2.57 |
| 21 | 0.1250 | 0.10 | 2.7 | 0.17 | 2.1 | 1.562 | 2.28 | 2.51 |
| 22 | 0.1250 | 0.10 | 2.7 | 0.17 | 2.1 | 0 | 2.28 | 2.51 |
| 23 | 0.1250 | 0.15 | 2.7 | 0.17 | 3 | 0.761 | 2.50 | 2.20 |
| 24 | 0.1250 | 0.20 | 2.7 | 0.17 | 3.9 | 1.345 | 2.36 | 2.10 |
| 25 | 0.1250 | 0.15 | 2.7 | 0.17 | 0 | 1.834 | 2.56 | 2.29 |
| 26 | 0.1250 | 0.20 | 2.7 | 0.17 | 0 | 1.66 | 2.51 | 2.21 |
| 27 | 0.1250 | 0.10 | 2.7 | 0.17 | 0 | 0.0097 | 2.45 | — |
| 28 | 0.1250 | 0.13 | 2.7 | 0.17 | 0 | 0.3031 | 2.31 | — |
| 29 | 0.1250 | 0.15 | 2.7 | 0.17 | 0 | 0.0109 | 2..36 | — |
| 30 | 0.0625 | 0.10 | 5.2 | 0.0 | 1.1 | 0 | 2.32 | 2.46 |
| 31 | 0.0625 | 0.10 | 5.2 | 0.0 | 2.2 | 0 | 2.31 | 2.42 |
| 32 | 0.0625 | 0.10 | 5.2 | 0.0 | 2 | 0 | 2.32 | 2.45 |
| 33 | 0.0625 | 0.15 | 5.2 | 0.0 | 3.1 | 0.7829 | 2.38 | 1.90 |
| 34 | 0.0625 | 0.20 | 5.2 | 0.0 | 3.9 | 0.5589 | 2.42 | 2.00 |
| 35 | 0.125 | 0.15 | 5.2 | 0.0 | 3.9 | 0.625 | 2.52 | 2.00 |
| 36 | 0.125 | 0.20 | 5.2 | 0.0 | 3.9 | 0.9345 | 2.39 | 2.00 |
| 37 | 0.0625 | 0.00 | 5.2 | 0.0 | 0 | 0.0114 | 2.77 | 2.70 |
| 38 | 0.0625 | 0.05 | 5.2 | 0.0 | 0 | 0.0156 | 2.60 | 2.50 |
| 39 | 0.0625 | 0.08 | 5.2 | 0.0 | 0 | 0.1384 | 2.46 | 2.37 |
| 40 | 0.0625 | 0.10 | 5.2 | 0.0 | 0 | 0.095 | 2.38 | 2.33 |
| 41 | 0.0625 | 0.15 | 5.2 | 0.0 | 0 | 0.013 | 2.27 | — |
| 42 | 0.0625 | 0.13 | 5.2 | 0.0 | 0 | 0.0122 | 2.34 | — |
| 43 | 0.0625 | 0.15 | 5.2 | 0.0 | 4.9 | 0.0147 | 2.17 | 2.24 |
| 44 | 0.0625 | 0.20 | 5.2 | 0.0 | 4.9 | 0.0138 | 2.25 | 2.13 |
| 45 | 0.125 | 0.15 | 5.2 | 0.0 | 0 | 0.1383 | 2.46 | 2.17 |
| 46 | 0.125 | 0.20 | 5.2 | 0.0 | 0 | 0.1144 | 2.21 | 2.25 |
| 47 | 0.0625 | 0.15 | 5.2 | 0.0 | 0 | 1.584 | 2.18 | 2.28 |
| 48 | 0.0625 | 0.20 | 5.2 | 0.0 | 0 | 1.383 | 2.36 | 2.18 |
| 49 | 0.125 | 0.15 | 5.2 | 0.0 | 0 | 1.748 | 2.30 | 2.25 |
| 50 | 0.125 | 0.20 | 5.2 | 0.0 | 0 | 1.072 | 2.36 | 2.18 |
| 51 | 0.0625 | 0.10 | 5.2 | 0.3 | 0.7 | 0 | — | 2.51 |
| 52 | 0.0625 | 0.15 | 5.2 | 0.3 | 0.8 | 0.5949 | 2.49 | 2.00 |
| 53 | 0.0625 | 0.20 | 5.2 | 0.3 | 2.7 | 0.2637 | 2.40 | 2.00 |
| 54 | 0.125 | 0.15 | 5.2 | 0.3 | 3 | 0.4055 | 2.49 | 2.10 |
| 55 | 0.125 | 0.20 | 5.2 | 0.3 | 3.2 | 0.448 | 2.41 | 2.00 |
| 56 | 0.0625 | 0.00 | 5.2 | 0.3 | 0 | 0.4387 | 3.13 | 2.88 |
| 57 | 0.0625 | 0.05 | 5.2 | 0.3 | 0 | 0.351 | 2.67 | 2.68 |
| 58 | 0.0625 | 0.08 | 5.2 | 0.3 | 0 | 0.2694 | 2.55 | 2.58 |
| 59 | 0.0625 | 0.10 | 5.2 | 0.3 | 0 | 0.3089 | 2.40 | 2.50 |
| 60 | 0.125 | 0.15 | 5.2 | 0.3 | 0 | 0.0095 | 2.32 | — |
| 61 | 0.125 | 0.13 | 5.2 | 0.3 | 0 | 0.0111 | 2.37 | — |
| 62 | 0.0625 | 0.0 | 7.9 | 0.0 | 0 | 0.1396 | — | — |
| 63 | 0.0625 | 0.08 | 7.9 | 0.0 | −0.2 | 0.0429 | 2.40 | 2.68 |
| 64 | 0.0625 | 0.10 | 7.9 | 0.0 | 1.3 | 0.403 | 2.50 | 2.42 |
| 65 | 0.0625 | 0.10 | 7.9 | 0.0 | 1.3 | 0 | 2.50 | 2.42 |
| 66 | 0.0625 | 0.15 | 7.9 | 0.0 | 3.9 | 1.055 | 2.39 | 1.90 |
| 67 | 0.0625 | 0.20 | 7.9 | 0.0 | 3.9 | 1.19 | 2.39 | 2.00 |
| 68 | 0.125 | 0.15 | 7.9 | 0.0 | 3.9 | 1.017 | 2.45 | 1.90 |
| 69 | 0.125 | 0.20 | 7.9 | 0.0 | 3.9 | 1.388 | 2.39 | 2.00 |
| 70 | 0.0625 | 0.15 | 7.9 | 0.0 | 0 | 0.0115 | 2.28 | — |
| 71 | 0.0625 | 0.13 | 7.9 | 0.0 | 0 | 0.0041 | 2.40 | — |

^{A}PDMS = Functionalized Polydimethylsiloxane

Statistical analysis of the fabric care compositions (1)-(71) was conducted with a Multiple Response Prediction Model having a 95% Confidence Index (CI) and an α=0.15 using MINITAB 18, commercially available from MINITAB, LLC of State College, Pa. The statistical analysis evaluated the respective amounts of the active ingredients (e.g., esterquat, polydimethylsiloxane, dialkyl ester, etc.), the lactic acid, the etidronic acid, the functionalized polydimethylsiloxane, the speed separation, the initial pH, and the pH after aging for 13 weeks. For the analysis, a Log reduction equal to or greater than 3 was considered acceptable. Additionally, pH values equal to or greater than 2.0 under aged conditions was considered acceptable while pH values below 2.0 were considered unacceptable.

The statistical analysis was utilized to determine suitable amounts of lactic acid and etidronic acid necessary to prepare fabric care compositions having satisfactory pH (≥2) and microbiological robustness (Log ≥3). Particularly, it was determined that satisfactory fabric care compositions including the esterquat in an amount of about 2.7 wt % and no functionalized polydimethylsiloxane could be represented by Formula (7):

0=−7.22+6.50·X+42.20·Y−33.80·X·Y Formula (7)

where X is the amount (wt %) of lactic acid present and Y is the amount (wt %) of etidronic acid present. It was further determined that satisfactory fabric care compositions including the esterquat in an amount of about 5.2 wt % and no functionalized polydimethylsiloxane could be represented by Formula (8):

0=−6.34+6.50·X+34.56·Y−33.80·X·Y Formula (8)

where X is the amount (wt %) of lactic acid present and Y is the amount (wt %) of etidronic acid present. It was also determined that satisfactory fabric care compositions including the esterquat in an amount of about 7.9 wt % and no functionalized polydimethylsiloxane could be represented by Formula (9):

0=−5.40+6.50·X+26.41·Y−33.80·X·Y Formula (9)

where X is the amount (wt %) of lactic acid present and Y is the amount (wt %) of etidronic acid present.

The statistical analysis was also utilized to determine pH and microbiological robustness for the fabric care compositions including varying amounts of the esterquat and the functionalized polydimethylsiloxane. Particularly, it was determined that satisfactory fabric care compositions including the esterquat in an amount of about 2.7 wt % the functionalized polydimethylsiloxane in an amount of about 0.17 wt % could be represented by Formula (10):

0=−5.04+6.50·X+42.20·Y−33.80·X·Y Formula (10)

where X is the amount (wt %) of lactic acid present and Y is the amount (wt %) of etidronic acid present. It was further determined that satisfactory fabric care compositions including the esterquat in an amount of about 5.2 wt % and the functionalized polydimethylsiloxane in an amount of about 0.3 wt % could be represented by Formula (11):

0=−3.90+6.50·X+34.56·Y−33.80·X·Y Formula (11)

where X is the amount (wt %) of lactic acid present and Y is the amount (wt %) of etidronic acid present. It was also determined that satisfactory fabric care compositions including the esterquat in an amount of about 7.9 wt % and the functionalized polydimethylsiloxane in an amount of about 0.47 wt % could be represented by Formula (12):

0=−4.46+6.50·X+26.41·Y−33.80·X·Y Formula (12)

where X is the amount (wt %) of lactic acid present and Y is the amount (wt %) of etidronic acid present.

Graphical representations of Formulas (7)-(12) are represented by FIGS. (1)-(6), respectively. It should be appreciated that the area bound by the hashed region represents fabric care compositions that are not satisfactory with respect to pH and microbiological robustness. Similarly, it should be appreciated that the remaining area represents fabric care composition and/or concentrations of lactic acid and etidronic acid that are satisfactory with respect to pH and microbiological robustness. It should further be appreciated that for each of Formulas (7)-(12) above, when the amount of lactic acid (wt %) and the amount of etidronic acid (wt %), or ‘X’ and ‘Y’, respectively, are provided, a satisfactory fabric care composition with respect to pH and microbiological robustness may be obtained if the resulting value is greater than 0. Conversely, if the value is less than 0, an unsatisfactory fabric care composition with respect to pH and/or microbiological robustness will be obtained.

As illustrated in Table 2, the fabric care compositions (20)-(24) generally indicated how increasing amounts of etidronic acid (e.g., about 0.08% to about 0.20%) affected the microbiological robustness when the amount of PDMS and lactic acid were maintained substantially constant. Particularly, increasing the amount of etidronic acid resulted in a corresponding increase in the Log value of from about 1.9 to about 3.9. This is especially surprising and unexpected as etidronic acid is a chelant when present in relatively low concentrations. As known to one having skill in the art, etidronic acid functions or acts as a chelant in concentrations of greater than 0 wt % and less than about 0.3 wt %, less than about 0.2 wt %, or less than 0.15 wt %. Etidronic acid, however, is not expected to affect the microbiological robustness, much less at such low concentrations.

The fabric care compositions (20)-(24) further demonstrated how etidronic acid affected the pH under aging conditions. Particularly, it was observed that pH decreased from about 2.57 to about 2.10 as the amount of the etidronic acid increased. It should be appreciated that the amount of lactic acid in each of the fabric care compositions (20)-(24) were maintained at about 0.125 wt %.

As illustrated in Tables 1 and 2, it was further demonstrated that in fabric care compositions including the esterquat in an amount of about 2.7 wt % and PDMS and fabric care compositions including about 7.9 wt % of the esterquat with or without PDMS, increasing etidronic acid and lactic acid increased speed separation values relative to a control including 0.1 wt % etidronic acid instead of 0.15 wt % or 0.17 wt % etidronic acid. The increased speed separation values implied relatively reduced or lower stability of the fabric care composition; however, the full stability protocol did not show implications about stability.

As also illustrated in Tables 1 and 2, it was demonstrated that in fabric care compositions including about 5.2 wt % of the esterquat with or without the PDMS, increasing the etidronic acid and lactic acid resulted in lower speed separation values. This implied increased stability of the fabric care composition.

In addition to the foregoing, it was demonstrated that in fabric care compositions including about 2.7 wt % of the esterquat, increasing etidronic acid from about 0.1 wt % to about 0.15 wt % or about 0.2 wt % while maintaining the amount of the lactic acid at about 0.125 wt % resulted in an increase in microbiological robustness of the fabric care compositions. It was also demonstrated that in fabric care compositions including about 5.2 wt % of the esterquat, increasing etidronic acid from about 0.1 wt % to about 0.15 wt % or about 0.2 wt % while maintaining the amount of the lactic acid at about 0.0625 wt % or 0.125 wt % resulted in an increased microbiological robustness of the fabric care compositions. It was further observed that increasing the amount of lactic acid from about 0.0625 wt % to about 0.125 wt % in fabric care compositions including about 5.2 wt % of the esterquat did not affect the microbiological robustness of the fabric care composition.

In fabric care compositions including about 5.2 wt % of the esterquat and the functionalized PDMS, increasing the amount of the lactic acid from about 0.0625 wt % to about 0.125 wt % resulted in an increase in the microbiological robustness, as fabric care compositions including about 5.2 wt % of the esterquat, the functionalized PDMS, and the lactic acid in an amount of 0.0625 wt % resulted in Log values of less than 3. Conversely, fabric care compositions including about 5.2 wt % of the esterquat, the functionalized PDMS, and the lactic acid in an amount of 0.125 wt % resulted in Log values of greater than or equal to 3.

As also illustrated in Tables 1 and 2, for fabric care compositions including about 7.9 wt % of the esterquat, increasing the amount of etidronic acid while maintaining the amount of the lactic acid increased the microbiological robustness; and maintaining or increasing the amount of lactic acid did not significantly impact that microbiological robustness.

As further illustrated in Tables 1 and 2, for fabric care compositions including about 7.9 wt % of the esterquat and the functionalized PDMS, increasing lactic acid from about 0.0625 wt % to about 0.125 wt % provided Log values greater than or equal to 3.

### Example 2

The ability of etidronic acid for maintaining whiteness and/or preventing yellowing while exhibiting greater microbiological robustness was evaluated. Particularly, two fabric care compositions were prepared with varying quelants. Particularly, a first fabric care composition was prepared with aminotrimethyl phosphonic acid (a quelant in conventional fabric care compositions) as the quelant, and a second fabric care composition was prepared with etidronic acid as the quelant. Each of the fabric care compositions were exposed to artificial sunlight for about 16 hours and subsequently analyzed for color degradation. It was demonstrated that the fabric care composition including the etidronic acid exhibited substantially similar color degradation as the fabric care composition including the aminotrimethyl phosphonic acid, a conventional quelant. Particularly, the fabric care composition including the etidronic acid exhibited a Delta E value of about 1.47 while the fabric care composition including the aminotrimethyl phosphonic acid exhibited a Delta E value of about 1.31.

### Example 3

The microbiological efficacy of varying fabric care compositions was evaluated. Particularly, fabric care compositions (72)-(74) including carrying amounts and/or ratios of lactic acid, etidronic acid, esterquats, or combinations thereof were prepared according to Table 3 and evaluated for their microbiological efficacy and/or robustness according to the AAPET. The AAPET analysis was performed according to the guidelines described by Quality Micro Procedure (QMIC) 0058—Acidophilic Bacteria >99.9%. The AAPET analysis was performed as discussed above. The results of the AAPET analysis are summarized in Table 4.

The Antimicrobial Preservative Effectiveness Test (APET) is a 28 days test that includes inoculating two product samples of 40 g with separate pools: a bacteria and yeast pool, and a mold pool. Subsequently, the samples are homogenized and incubated for seven days. After incubation, an aliquot is taken and the amount of the mold and microorganisms/bacteria that survived are counted. Next, a new bacteria pool is added into the sample and incubated for another seven days. After the seven days (14 days total), another aliquot is taken and the amount of the microorganisms/bacteria that survived is counted. This procedure is repeated for a total of 28 days. To pass the test for bacteria, the logarithmic reduction of the bacteria must be at least 3 (99.9%) each time the aliquot is taken for testing. To pass the test for mold, the logarithmic reduction must be at least 2 each time the aliquot is taken for testing.

TABLE 3
Fabric Care Compositions (72)-(74)

| Component | (72) | (73) | (74) |
|---|---|---|---|
| Demineralized Water | 94.83 | 94.43 | 94.43 |
| 1-Decanol, ethoxylated | 2.00 | 2.00 | 2.00 |
| Hydroxyethyl Celullose | 0.40 | 0.40 | 0.40 |
| Glycerin | 1.60 | 1.60 | 1.60 |
| Isopropyl Palmitate | 0.10 | 0.10 | 0.10 |
| LA - 80% | 0.10 | 0.50 | 0.30 |
| HEDP | 0 | 0 | 0.20 |
| Excipients | Balance | Balance | Balance |
| Total | 100 | 100 | 100 |

TABLE 4
AAPET and APET Analysis of Fabric Care Compositions (72)-(74)

| Component | (72) | (73) | (74) |
|---|---|---|---|
| Bacteria/Log Reduction, 8 wks | Pass | Pass | Pass |
| Mold/Log Reduction, 8 wks | Fail | Fail | Pass |
| AAPET/Log Reduction, 8 wks | Fail | Pass | Pass |

Table 3 illustrates the comparison between varying fabric care compositions (72)-(74) having different amounts of lactic and etidronic acid levels, and in Table 4 illustrates the AAPET and APET results of these formulations. For bacteria, all fabric care compositions (72)-(74) met the acceptance criteria and therefore, they are considered microbiologically robust. For the AAPET, it is demonstrated that if the amount of lactic acid is increased from 0.1% (72) to 0.3% (73) the test passed successfully, meaning the lactic acid improve the microbiology robustness for the AAPET. For the mold test, it was demonstrated that even after increasing the level of lactic acid from 0.1% (72) to 0.3% (73) the fabric care compositions did not meet the criteria and therefore the fabric care compositions failed this test after 8 weeks of aging. Relating the results explained above with the fabric care composition with Etidronic Acid (74), it can be seen that with lower lactic acid content that formulation (73) the AAPET is passed successfully and the mold test, contrasting with previous results, is also passed, meaning that the presence of etidronic acid in the formula improves the microbiology robustness for all conducted tests.

The present disclosure has been described with reference to exemplary implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof.

1. A fabric care composition, comprising:
a preservative system comprising one or more preservatives;
a cationic softener;
a cationic polymer; and
an organosilicone.

2. The fabric care composition of claim 1, wherein the one or more preservatives comprises one or more phosphonic acids or salts thereof, one or more organic acids, or combinations thereof.

3. The fabric care composition of claim 2, wherein the one or more phosphonic acids or salts thereof comprises one or more of 1-hydroxyethane-1,1-diphosphonic acid, N,N,N-tri(phosphonomethyl)amine, 1,2-ethylenediaminetetramethylenephosphonic acid (EDTMP), diethylenetriamine pentamethylene phosphonic acid (DTPMP), N,N,N-tri(1-phosphonoethyl)amine, N,N,N-tri(1-phosphonopropyl)amine, N,N,N-tri(2-phosphonoprop-2-yl)amine, or combinations thereof.

4. The fabric care composition of claim 3, wherein the one or more phosphonic acids or salts thereof comprises 1-hydroxyethane-1,1-diphosphonic acid.

5. The fabric care composition of claim 2, wherein the one or more organic acids comprises lactic acid.

6. The fabric care composition of claim 1, wherein the cationic softener comprises an esterquat.

7. The fabric care composition of claim 6, wherein the esterquat is represented by formula (1): 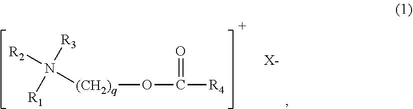
wherein R₄ represents an aliphatic hydrocarbon group having from 8 to 22 carbon atoms, R₂ and R₃ represent (CH₂)ₛ—R₅,
wherein R₅ represents an alkoxy carbonyl group containing from 8 to 22 carbon atoms, benzyl, phenyl, (C1-C4)-alkyl substituted phenyl, OH or H,
wherein R₁ represents (CH₂)ₜ R₆,
wherein R₆ represents benzyl, phenyl, (C1-C4)-alkyl substituted phenyl, OH or H,
wherein q, s, and t, each independently, represent an integer from 1 to 3, and
wherein X⁻ is a softener compatible anion.

8. The fabric care composition of claim 1, wherein the cationic softener comprises a dialkylester of triethanolammonium methyl sulfate.

9. The fabric care composition of claim 1, wherein the cationic polymer comprises a polyquat.

10. The fabric care composition of claim 1, wherein the cationic polymer comprises Polyquaternium-7.

11. The fabric care composition of claim 1, wherein the organosilicone comprises one or more of a polyalkyl silicone, an aminosilicone, a siloxane, a polydimethylsiloxane, an ethoxylated organosilicone, a propoxylated organosilicone, an ethoxylated/propoxylated organosilicone, or mixtures thereof.

12. The fabric care composition of claim 1, wherein the organosilicone comprises a functionalized polydimethylsiloxane.

13. The fabric care composition of claim 12, wherein the functionalized polydimethylsiloxane comprises a mercaptoalkyl functional group, an alkylaminomethylacrylate functional group, or combinations thereof.

14. A method for preparing the fabric care composition of claim 1, the method comprising contacting the preservative system, the cationic softener, the cationic polymer, and the organosilicone with one another.

15. A method for increasing microbiological robustness of a fabric care composition, the method comprising contacting a preservative system comprising one or more phosphonic acids and one or more organic acids with one another, wherein the one or more phosphonic acids comprises 1-hydroxyethane-1,1-diphosphonic acid, and wherein the one or more organic acids comprise lactic acid.
